(19) United States
(12) Patent Application Publication
(10) Pub. No.: US 2012/0005183 A1
(43) Pub. Date: Jan. 5, 2012

(54) SYSTEM AND METHOD FOR AGGREGATING AND INTERACTIVE RANKING OF SEARCH ENGINE RESULTS

(75) Inventors: Dante Monteverde, Barrington Hills, IL (US); Arsen Vladimirskiy, Chicago, IL (US)

(73) Assignee: EMERgency24, Inc., Chicago, IL (US)

(21) Appl. No.: 12/827,772

(22) Filed: Jun. 30, 2010

(51) Int. Cl. G06F 17/30

(52) U.S. Cl. 707/706; 707/E17.108

(57) ABSTRACT

Systems and methods are disclosed for a search engine interface presented to a user in which a search query is input and run on a plurality of individual search engines. The system supports selection by the user of positive or relevant search results hits, and supports deletion or rejection of negative or irrelevant search results hits. The system allows the user to compile a list of personal best hits, and allows the user to collaborate on creating a multi-user overall best result or results list. Subsequent users have access to the collaborative efforts of the multi-users best results.

### FIELD OF THE INVENTION

The invention relates to Internet search engines and, in particular, to systems and methods for aggregating and displaying search results provided from a plurality of search engines, searches run on the search engines generally simultaneously, and for interactive ranking of the aggregated search results by users or administrators.

### BACKGROUND

Currently, many Internet search engines are available. Many companies drive their revenues with the traffic generated by their search engines, such as Google®. However, a search engine is only as complete as its database of captured and indexed webpages, and a search engine is only as useful as its ability to respond to a search query by returning search results that are relevant.

There has long been an elaborate back and forth between search engine designers and administrators and website operators that determines how the search engine views a particular website and its associated pages, which in turn determines how the search engine provides the website and its pages in response to a search query. Generally speaking, a number of techniques are used to capture and index a webpage, such as using special applications known as spiders or crawlers or such as administrators or website operators directly identifying the website and pages.

Search engines index and store the identifiable information on a webpage. The principle information that can be identified, indexed, and stored, is the textual content of the webpage, including any page titles. Website operators have utilized this fact to deceive, in essence, the search engines. Through various artifices, website operators will bury text in a webpage that either has little to no bearing on the actual content of the webpage, or will simply make the page appear much more relevant to many more topics or queries that the content would otherwise merit.

Thus, there are certain difficulties for end users of search engines. A first is the fact that each search engine administrator builds their database independently, and there is no universal database that contains all known webpages.

A second difficulty is the fact that search results for a search query need to be individually examined for relevance to the search query, and frequently the search results prove less relevant than anticipated. A typical set of search results is presented as a list of a number of hits, each hit including a title, an excerpt of text from the webpage intended to include at least some of the search query terms in context, and a link. Some search engines provide a set of sponsor search results in the form of a second, separate list of hits. The user who input the search query uses the title, the excerpted text, and possibly the link itself to make an initial determination as to whether the link is likely to be useful. The user then proceeds to follow one or more of the links to examine the actual webpages, or may decide that the search results are clearly not likely to produce useful result and proceeds with running a new query or with modifying the search terms of the original query.

One attempt to address some of the deficiencies of search engines is Copernic Agent software provided by Copernic, Inc., of Quebec, Canada. The Agent is a downloadable software application which typically runs adjacent a webbrowser; Agent does not open or display webpages within itself, instead causing the webpages to be opened in the user's default browser. To use, a search query is input to Agent, which in turn searches a plurality of search engines simultaneously. The search results are then presented to the user as a list of hits, each hit containing the expected information of a title, some excerpted text from the webpage, and the webpage Internet address (URL) as a link; clicking the link causes a page to open in the browser. The major benefit of Copernic Agent is the ability to search across multiple search engines and have the results from all the searches provided in a single list.

Agent has a number of shortcomings. Agent provides a score or ranking for the search results, though it is not clear whatsoever how the score is derived or how Agent chooses to intermix the results from the different engines. Agent supports annotation for a single user; that is, a user can add comments to the hits and can delete hits. However, the results for Agent are stored locally; when Agent is reopened, the previous searches and same search results are displayed, but not updated unless the user direct such to be done. More importantly, the local storage means that the annotations or other modifications of the list of hits are also local and are not viewable by other users.

Finally, the fact that Agent mixes the results of the different search engines prevents Agent from using certain engines. A number of well-know search engines allow other website search applications to be “powered” by the search engine. However, the general rules are that acknowledgement must be provided of the underlying search engine, and that aspects of the underlying search engine are not to be modified or filtered. Furthermore, it appears that Copernic agent indexes and analyzes the search results (hits) from the various websites to produce a score with which to rank the various hits, and such may be prohibited by some search engines.

It should also be noted that only two ways are currently known for collecting links for future use. The first manner is for users to bookmark pages or sites. One needs to select a title for the bookmark and organize the bookmarks under folders in order to be able to recognize the bookmarks at a later date. For persons who run numerous searches, this becomes a relatively laborious task to organize the relevant hits for a particular search within a folder. The other is maintaining the searches in Copernic Agent.

Accordingly, there has been a need for an improved search engine aggregator that provides the ability for users to identify and organize the best search results for a search query.

### SUMMARY

In accordance with an aspect, a web-based computer system search engine for receiving search queries and returning search results is disclosed including an input for a search query, the input displayed on a webpage of a browser provided at a remote computer by a user, a processor for receiving the search query from the user computer and for directing the search query to be run on at least one search engine, a display for presenting the search results in the form of hits from each search engine on a results webpage, wherein the results webpage allows for user selection of at least one hit, the system receiving and storing the user selected hits.

In some forms, the webpage presents the user selected hits in a separate selection list. The separate selection list may permit moving and ranking of the hits thereof. The separate selection list may permit annotations to be added by the user for one or more of the hits. The annotations may be processed by the processor and stored by the system, wherein the system may provide the hits with the annotations in response to a substantially similar search query by subsequent users.

In some forms, the results webpage includes a negative indicator and a positive indicator for each hit for use by the user. The selection of the negative indicator may delete the hit from the results webpage. The selection of the positive indicator may direct the processor to store the hit as a user selected hit.

In some forms, the processor retrieves search results for the search query from a plurality of search engines, and the results webpage presents the search results for each search engine as respective lists of hits. The system may include a selector for selecting one of the respective lists of hits for display on the webpage. The webpage may presents the user selected hits in a separate selection list, and the selector further may allow selection of the user separate selection list.

In some forms, the user selected hits for the search query and substantially similar search queries are compiled in the storage and are analyzed by the processor to determine a collaborator set of best hits results. The processor may retrieve search results for the search query from a plurality of search engines, the results webpage may present the search results for each search engine as respective lists of hits, the webpage may present the user selected hits in a separate selection list, the system further may include a selector for selecting from one of the respective lists of hits, the user separate selection list, and the best hits results, the selected list being displayed on the webpage and on the display.

In another aspect, a web-based computer system search engine for receiving search queries and returning search results is disclosed including an input for a search query, the input displayed on a webpage of a browser provided at a remote computer by a user, a processor for receiving the search query from the user computer and for directing the search query to be run on at least one search engine, a display for presenting the search results in the form of hits from each search engine on a results webpage, wherein the results webpage allows for user designation of at least one hit as a collaborator hit, the system receiving and storing collaborator hits from a plurality of users, the system processing the collaborator hits to determine a set of best hits, the system presenting on the display the set of best hits to subsequent users in response to subsequent substantially identical queries.

In a still further aspect, a method of providing search results to an Internet-based search query from a user at a remote computer is disclosed including the steps of displaying on a display of the remote computer a user interface of a search application including providing an input for a search query, receiving the search query at a server, processing the search query by the server, retrieving search results in the form of hits from a storage, the search results including one or more of the following: search engine results generated by at least one search engine in response to the search query; stored search results previously generated in response to substantially the same search query by the user; stored search results previously selected by the user with respect to substantially the same search query by the user; and collaborator search results stored on the storage, the method also including the steps of displaying the search results on the remote computer, and permitting user designation of at least one hit from the search results, the system receiving and storing the user designated hits.

In some forms, the step of permitting user designation includes permitting the user to designate the at least one hit as a personal best result, the system storing the personal best results as the previously selected stored search results.

In some forms, the step of permitting user designation includes permitting the user to designate the at least one hit as a best hit, the method further including the step of compiling best hits from a plurality of users for substantially the same search query, processing the compiled best hits, determining a set of best hits, and storing the best hits as the collaborator search results.

In some forms, the step of retrieving search results in the form of hits from a storage includes directing the search be performed on at least two search engines.

In some forms, the method further includes the steps of selecting an annotator, inputting annotations for at least one hit, and storing the annotations in the storage. The step of displaying the search results including the collaborator results may includes displaying with the user input annotations therefor.

### BRIEF DESCRIPTION OF THE DRAWINGS

In the Figures, FIG. 1 is a graphical representation of a results window interface for a search engine incorporating the systems and methods of the present invention;

FIG. 2 is a graphical representation of a home page for the search engine of FIG. 1;

FIG. 3 is a second graphical representation of a results window interface for the search engine of FIG. 1;

FIG. 4 is a third graphical representation of a results window interface for the search engine of FIG. 1; and

FIG. 5 is a graphical representation of a system of the present invention.

### DETAILED DESCRIPTION

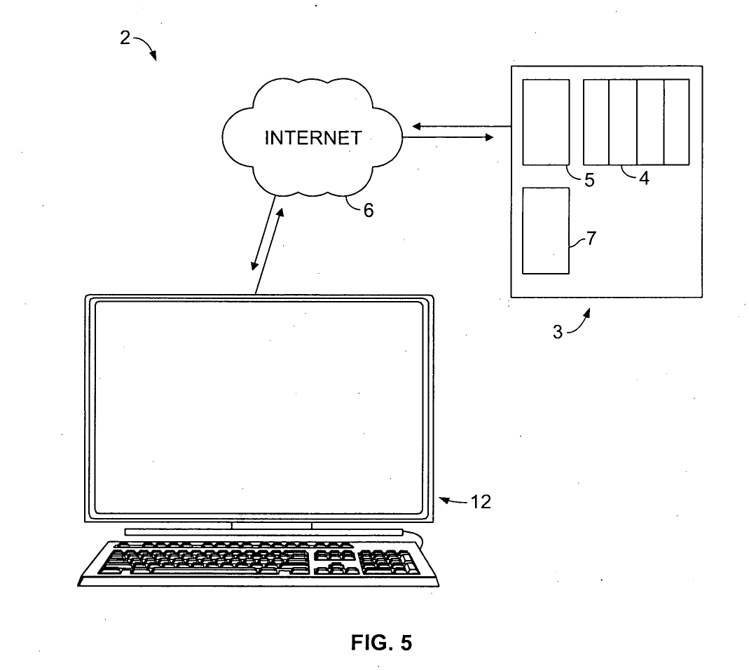

Referring initially to FIG. 1, a results page 20 generated by the systems 2 (FIG. 5) and methods of the present invention is illustrated as displayed on a conventional web browser 10 on a computer 12 of an end user. In the present embodiment, the results page 20 has a refine search query window 22, a new search query window 24, and a results area 26.

The results area 26 includes the results 28 from a plurality of predetermined search engines. In order to comply with the terms of use for various search engines, the results area 26 includes a selector 30 in the form of a plurality of tabs 32, one of each tab 32 being designated to display the search results 28 from a specific search engine only. For the illustrated embodiment, there is a first tab 32a for a first search engine, a second tab 32b for a second search engine, and a third tab 32c for a third search engine, though any number of additional tabs 32 and search engines may be incorporated into the systems 2 and methods of the present invention and into the selector 30. As will be discussed in greater detail below, a user inputs a query 40 (such as into the query windows 22, 24), the present invention runs the search query 40 on the search engines, and the results page 20 displays the tabs 32, selection of which causes the results 28 from the correlated search engine to be displayed in the results area 26. As can be seen, the results 28 for each search engine under its tab 32 also include designators 33 indicating that a particular hit 70 was also identified by another search engine.

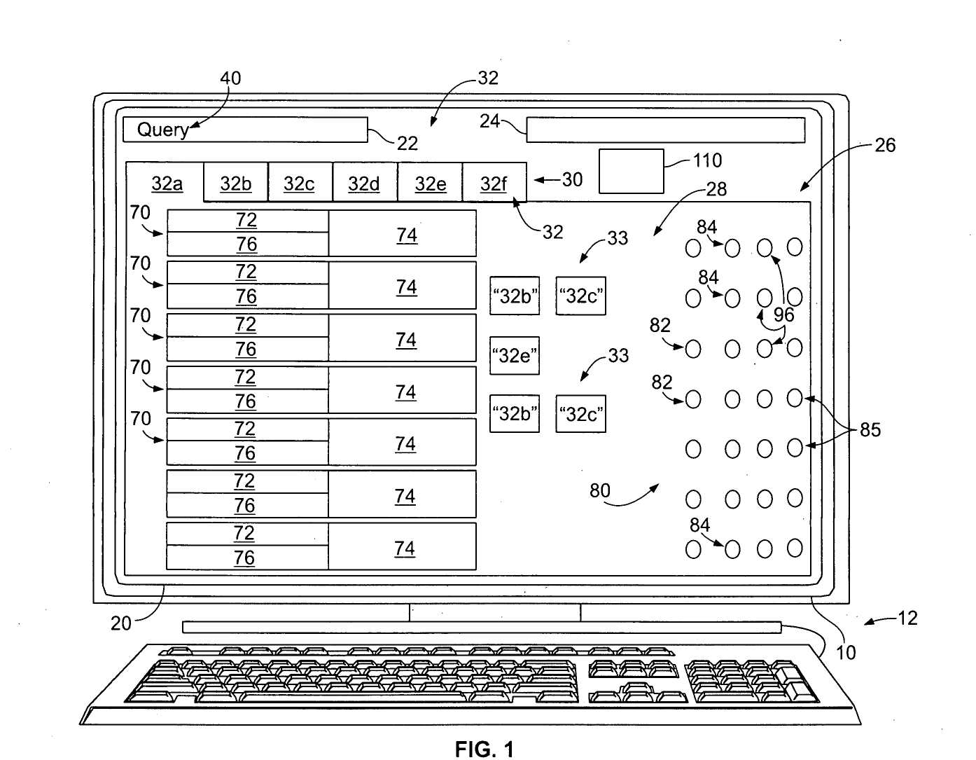

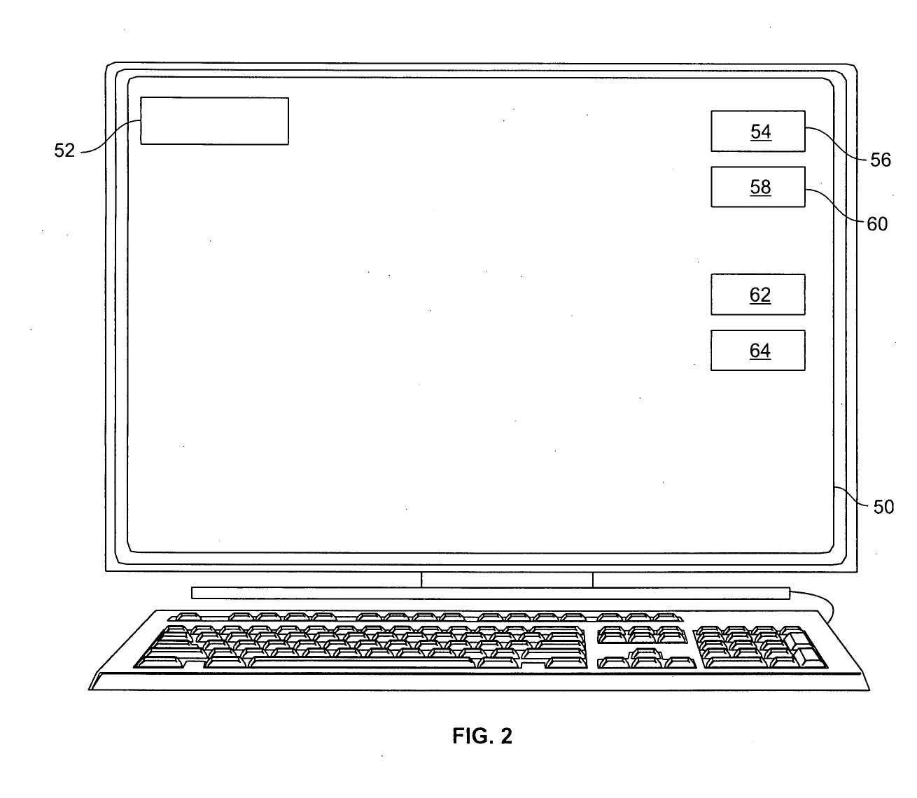

Turning to FIG. 2, a home page 50 generated by the systems 2 and methods of the present invention is illustrated as displayed on the browser 10. The home page 50 is similar to other search engine home pages in that there is an initial query window 52. However, the present invention allows one to maintain and recall previous searches, as will be discussed in greater detail below. Towards this end, a user may login to the system 2 by inputting a user name 54 into a user window 56 and by inputting a password 58 into a password window 60. Once logged in, the home page 50 provides a link 62 for reviewing previous searches. Alternatively, the act of logging in may lead the user directly to a list of previous searches. A logout link 64 is also provided.

The system 2 allows interactivity between users in response to the search results 28. As can be seen in FIG. 1, each of the results 28 is in the form of a hit 70. Each hit 70 includes a title 72, some portion of excerpted text 74 to provide a contextual indication of how the hit 70 relates to the search query 40, and link 76 showing the address (URL) for the website or webpage of the hit 70. The results page 20 includes feedback indicators 80 which, in the present form, include a positive indicator 82 and a negative indicator 84. More appropriately, the positive indicator 82 can be used to designate the hit 70 as a favorite result, as a merely relevant result, or simply be used to save the hit 70 for later. The negative indicator 82 can be used to designated the hit 70 as a broken link, as being irrelevant, or to simply delete the hit 70 from the list of results 28.

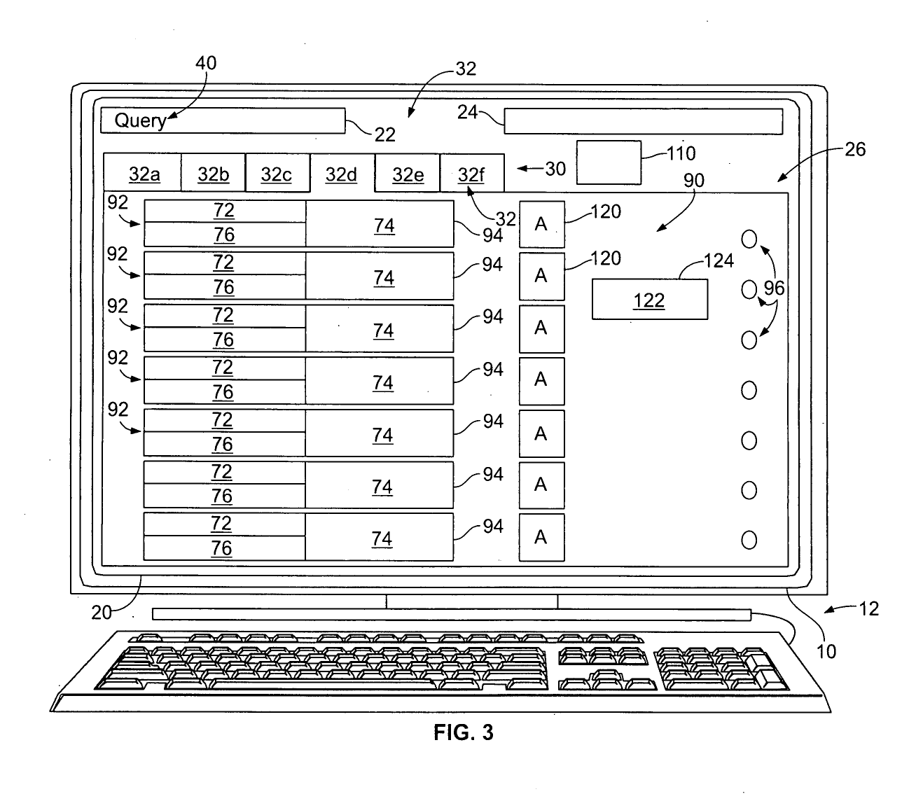

Selection of the positive indictor 82 causes the hit 70 to populate a personal results list 90, as shown in FIG. 3. More specifically, a user may input the query 40 as discussed above and move through the various tabs 32 for the various search engines to review the search results 28 produced by each. The user may select the positive indicator 82 so that particular hits 70 are copied into a system storage 4 (FIG. 5) and designated as personal preferred or “best” hits 92. When the user selects personal tab 32d, the personal best hits 92 are displayed.

The personal best hits 92 may be ranked by the user. In the present form, each personal best hits 92 is framed, such as in a box 94, and contains the same title 72, text 74, and link 76. Clicking on a designated portion such as the title 72 or link 76 causes the browser to load the link 76. Clicking and holding on any other portion of the box 94 allows the pointer to “grab” the hit 92, while dragging of the mouse allows the user to move the hit 92 up or down within the results list 90. Up to this point, the personal best hits 92 are generally for a user's own needs.

The user can then contribute to the overall body of search so that others may benefit from the user's efforts. Each user who has compiled personal best results list 90 can essentially return the ranking back to the system 2. As can be seen, there is an upload selection 96 on the results page 20 and, preferably, within the personal best results list 90, in the present form illustrated as a radio button 96. Upon clicking the upload selection 96, the personal best results list 90 is forwarded to the system 2 for storage in the storage 4 thereof.

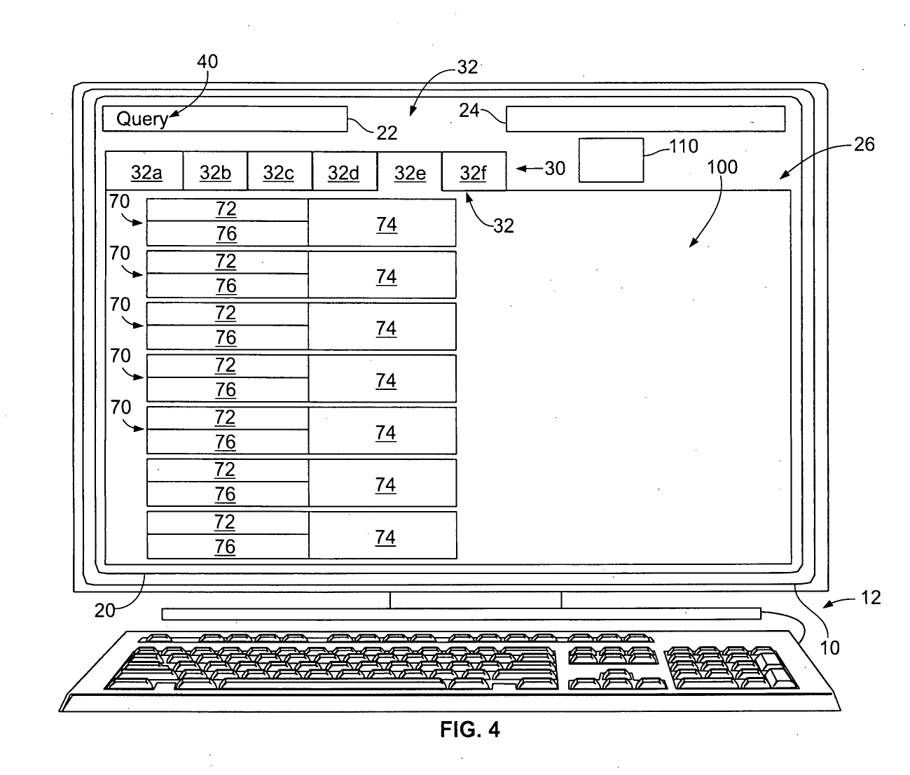

For many search terms or queries, same or nearly identical searches may be run by many users. After a number of users have run the same search query 40 and determined their respective personal best results lists 90, which have been returned to the system 2, all the returned lists 90 may be compiled and analyzed by the system 2. In other words, the system 2 combines the rankings provided by each user to determine which sites users found relevant and which were the consensus as the most relevant or useful. This becomes a best search list, referred to herein as the collaborator list 100, which can be accessed by selection of tab 32e, as shown in FIG. 4.

The collaborator list 100 allows a user to leverage the experience of many other users. As discussed, a user typically runs every search from scratch, or modifies a search run from scratch. The present system 2 allows a user to input a search query 40 and receive a variety of lists of results 28, including a result list 28 for each separate search engine, a personal best results 90 if the user has previously searched the query 40, and a collaborator list 100 if a number of users have previously searched the query 40. In this manner, a user can much more easily find the best websites from the collaborator list 100, as voted on by actual users, a user can be assured that results in the collaborator list 100 are, indeed, relevant, and a user can quickly locate their own previous efforts in the personal best results list 90. In a most preferred form, the default for a search for which a collaborator list 100 has already been produced is for the collaborator tab 32e to be presented to the user upon entry of the search query 40.

In another form, a user may simply designate one or more best search results for the collaborator list 100. In other words, the feedback indicators 80 include, in addition to the positive and negative indicators 82, 84, a best indicator 85, as can be seen in FIG. 1. Selection of the best indicator 85 informs the system 2 that the selected hit 70 is the best or one of the best hits 70. The system 2 then stores and collects this information from a plurality of users until a sufficient number (i.e., statistically significant number) of users has made a selection, likely in the order of 10-25 users. Until one or more hits 70 have been selected as best by use of the best indicator 85, the collaborator list 100 may remain unpopulated, as there is no consensus.

The user is thus not subject to the tricks website operators and designers will utilize to draw traffic to their sites. For instance, a website that buries keywords in a background may be identified and indexed by a search engine, and then presented to a user in response to a search query 40, despite the webpage being otherwise irrelevant to the search query 40. However, a user will likely utilize the negative indicator 84 or, at the minimum, not select the website for the personal best results list 90, which means that the website would not be included in the collaborator list 100. In short, the collaborator list 100 presents the hits 70 that have already been vetted and determined meritorious in response to a search query 40.

It should be noted that one need not login to the system 2 in order to utilize the search capabilities or the collaborator list 100. Furthermore, even the personal best list 90 may be used by, for instance, placing a temporary session cookie on the user's computer in a manner that is well-known and widely accepted.

In the present form, it is desired to have users provide feedback on the hits 70 generated by the searches. In this manner, users are encouraged to participate in the community. Despite the general cooperativeness of the technology community that has fueled the spectacular growth of the internet as a useful tool in many ways, altogether people are not always entirely altruistic. To incentivize collaboration, registered users may be compensated (such as by designating a Paypal® account, or a donation may be made to a charitable organization). The system 2 itself may generated revenue by providing sponsor links under a sponsor tab 32f, and may use other well-known search engine-based advertising methods for generating revenue.

A user may annotate the personal best results list 90. As can be seen in FIG. 3, a annotator 120 in the form of an icon is provided proximate each result 28 of the personal best results list 90. In other forms, the annotator 120 may be in the form of a window, or a link, or other manner for indicating to the webpage 20 and the system 2 that the user desires to add information to the hit 70. The icon 120 is preferred because it minimizes space on the page in the event a user does not wish to provide any annotations or remarks. By selecting the annotator 120, a user is allowed to input annotations 122 into an annotation window 124. It should be noted that the annotator 120 may be provided for any of the results lists, e.g., 32a-32d, et seq., though only shown on FIG. 3 for the best results list 90 for sake of convenience. For instance, a non-best link 70 may actually be a very disappointing or negative experience, and the user may provide an annotation of the same.

As an example of the use of annotations 122 and the annotator 120, a user may search for television retailers. The results page 20 will provide the above-discussed tabs 32 (e.g., 32a-32c) for the different search engines. If there is a collaborator list 100, such will also be provided, and any hits 70 of the collaborator list 100 may include annotations 122 from the users who collaborated to create the collaborator list 100.

In any event, the user may go through the various search results 28 and select a number of hits 70 to move to their personal best results list 90. Again as examples, a user may annotate a hit 70 with comments such as “Free Shipping,” “Great Product Reviews, Not-so-great Prices,” “Longest Extended Warranties,” “Where Joe got his TV,” etc. A user may select whether the annotations 122 are to be available to other users or whether they should remain only on the personal best results list 90, and these may be selected individually so that a comment such as “Where Joe got his TV” may remain personal while others such as “Free Shipping” may be made available to subsequent searchers.

It should also be noted that the results page 20 includes a recent searches listing 110 so that one can easily review previous searches. It is within the scope of the recent searches listing 110 that a user may select recent searches chronologically, such as for the past 5 days or another period of time, or may select recent searches based on their order, such as the last 10 or 20 search queries, regardless of how long it has been.

Care must be taken in designation of the collaborator list 100. Often times, a person with little knowledge of a field may begin a search with imprecise terms and queries 40. It is through one or more initial searches that the user is able to even determine the proper search query 40. However, the system 2 needs to recognize that all searches run will not result in the user producing a personal best list 90.

One manner for addressing this is limiting who can be a collaborator, such as by restricting such status to those with particular expertise such that no early trial-and-error searches are performed. The benefit of this is that it will reduce those who are not ‘in the know’ from distorting the process, and it will limit the number of searches which any one collaborator can do. The detriment is that it would take much longer to develop a critical mass of collaborators and it is difficult to assess the qualifications of a collaborator. Another manner may simply be for the system 2 to ignore personal best result lists 90 until the user indicates satisfaction with the list 90. The benefit of this is that data is generated much more quickly, while the detriment is that someone may attempt to generate a personal income stream by churning searches and uploading their personal best result lists 90; this detriment may be reduced in potential by limiting the number of searches by a collaborator in a given period of time. In variants of such limit, the length of time spent on designating the personal best results list 90 for a particular search may be compared with an average or a mean for the same or a similar search by other users, the number of websites visited may be compared with an average for other users, and the length of time from search query to designation of a personal best search list 90.

It is contemplated that a personal best search list 90 may be a single hit 70, and that the collaborator list 100 may be a single hit 70 that was most commonly designated the best by a plurality of users.

Turning now to FIG. 5, the system 2 is illustrated. The system 2 includes a set of servers 3 including the storage 4 such as a database for storage of webpages and indexes therefor, indexes of web addresses, user accounts including user names 54 and passwords 58, and searches performed by the users, personal best search lists 90, and collaborator lists 100, as examples. The system 2 includes a communications module 5 including, for instance, routers for connecting with the Internet 6 and communicating with remotely located end user computers 12 via the same. The servers 3 further include processing circuits 7 for processing search queries 40, running searches on external search engines, and communicating with the end user computer 12 including delivering webpages such as the results page 20 and search results 28 thereto. It should be noted that the system 2 may also support a proprietary search engine within the servers 3.

For each of the aspects discussed herein there is no time limit and the system is fully dynamic. In greater detail, a user can build a list 90 or contribute to a collaborator list 100 at any time, either while performing a specific search or returning at any later point. For instance, a user may find initial interaction with a e-tailer or e-commerce site to be fantastic and may provide annotations/comments or a ranking for the site based on the ease of use and the quality of selection. The user may later return to their comments and revise them to discuss how easy or poor customer service turned out when the product failed or arrived damaged or failed to arrive. As another example, a subscriber to a periodical may return to describe how subscription rates skyrocketed after the first year or how well the publisher treats its subscribers by providing long term discounts.

While the invention has been described with respect to specific examples including presently preferred modes of carrying out the invention, those skilled in the art will appreciate that there are numerous variations and permutations of the above described systems and techniques that fall within the spirit and scope of the invention as set forth in the appended claims.

What is claimed is:

1. A web-based computer system search engine for receiving search queries and returning search results, the system comprising:
an input for a search query, the input displayed on a webpage of a browser provided at a remote computer by a user;
a processor for receiving the search query from the user computer and for directing the search query to be run on at least one search engine;
a display for presenting the search results in the form of hits from each search engine on a results webpage,
wherein the results webpage allows for user selection of at least one hit, the system receiving and storing the user selected hits.

2. The system of claim 1 wherein the webpage presents the user selected hits in a separate selection list.

3. The system of claim 2 wherein said separate selection list permits moving and ranking of the hits thereof

4. The system of claim 2 wherein said separate selection list permits annotations to be added by the user for one or more of the hits.

5. The system of claim 4 wherein the annotations are processed by the processor and stored by the system, and wherein the system provides the hits with the annotations in response to a substantially similar search query by subsequent users.

6. The system of claim 1 wherein the results webpage includes a negative indicator and a positive indicator for each hit for use by the user:

7. The system of claim 6 wherein selection of the negative indicator deletes the hit from the results webpage.

8. The system of claim 6 wherein selection of the positive indicator directs the processor to store the hit as a user selected hit.

9. The system of claim 1 wherein the processor retrieves search results for the search query from a plurality of search engines, and the results webpage presents the search results for each search engine as respective lists of hits.

10. The system of claim 9 including a selector for selecting one of the respective lists of hits for display on the webpage.

11. The system of claim 9 wherein the webpage presents the user selected hits in a separate selection list, and the selector further allows selection of the user separate selection list.

12. The system of claim 1 wherein the user selected hits for the search query and substantially similar search queries are compiled in the storage and are analyzed by the processor to determine a collaborator set of best hits results.

13. The system of claim 12 wherein the processor retrieves search results for the search query from a plurality of search engines, and the results webpage presents the search results for each search engine as respective lists of hits, the webpage presents the user selected hits in a separate selection list, the system further including a selector for selecting from one of the respective lists of hits, the user separate selection list, and the best hits results, the selected list being displayed on the webpage and on the display.

14. A web-based computer system search engine for receiving search queries and returning search results, the system comprising:
an input for a search query, the input displayed on a webpage of a browser provided at a remote computer by a user;
a processor for receiving the search query from the user computer and for directing the search query to be run on at least one search engine;
a display for presenting the search results in the form of hits from each search engine on a results webpage,
wherein the results webpage allows for user designation of at least one hit as a collaborator hit, the system receiving and storing collaborator hits from a plurality of users, the system processing the collaborator hits to determine a set of best hits, the system presenting on the display the set of best hits to subsequent users in response to subsequent substantially identical queries.

15. A method of providing search results to an Internet-based search query from a user at a remote computer, the method including the steps of:
displaying on a display of the remote computer a user interface of a search application including providing an input for a search query;
receiving the search query at a server;
processing the search query by the server;
retrieving search results in the form of hits from a storage, the search results including one or more of the following:
search engine results generated by at least one search engine in response to the search query,
stored search results previously generated in response to substantially the same search query by the user,
stored search results previously selected by the user with respect to substantially the same search query by the user,
collaborator search results stored on the storage;
displaying the search results on the remote computer; and
permitting user designation of at least one hit from the search results, the system receiving and storing the user designated hits.

16. The method of claim 15 wherein the step of permitting user designation includes permitting the user to designate the at least one hit as a personal best result, the system storing the personal best results as the previously selected stored search results.

17. The method of claim 15 wherein the step of permitting user designation includes permitting the user to designate the at least one hit as a best hit, the method further including the step of compiling best hits from a plurality of users for substantially the same search query, processing the compiled best hits, determining a set of best hits, and storing the best hits as the collaborator search results.

18. The method of claim 15 wherein the step of retrieving search results in the form of hits from a storage includes directing the search be performed on at least two search engines.

19. The method of claim 15 further including the steps of selecting an annotator, inputting annotations for at least one hit, and storing the annotations in the storage.

20. The method of claim 19 wherein the step of displaying the search results including the collaborator results includes displaying with the user input annotations therefor.
